(19) United States
(12) Patent Application Publication
(10) Pub. No.: US 2025/0324347 A1
(43) Pub. Date: Oct. 16, 2025

(54) PROXIMITY-BASED CONTROL FOR VOIP CLIENT AUTHORIZATION

(71) Applicant: Microsoft Technology Licensing, LLC, Redmond, WA (US)

(72) Inventors: Amer Aref Hassan, Kirkland, WA (US); Roy D. Kuntz, Kirkland, WA (US); Gareth L.E. Bridges, Redmond, WA (US); Michele Ann Kinsey, Shoreline, WA (US)

(21) Appl. No.: 18/637,234

(22) Filed: Apr. 16, 2024

(51) Int. Cl. H04W 48/04; H04W 12/104; H04W 12/63; H04W 64/00

(52) U.S. Cl. CPC H04W 48/04; H04W 12/104; H04W 64/003; H04W 12/63

(57) ABSTRACT

The present invention relates to telecommunications and specifically to methods and systems for enabling Internet-based telephone calls using Over-the-Top (OTT) communication services while ensuring compliance with jurisdictional regulatory requirements. Described herein are techniques for binding a non-mobile device, such as a laptop or tablet, to a mobile device capable of providing real-time location information. The binding is established through a local proximity network using short-range wireless communication protocols. The mobile device transmits its connectivity status and location data to either the non-mobile device or a cloud-based communication service, which then acts as a gatekeeper to permit or inhibit call initiation based on the received status information. This system ensures that calls made from the non-mobile device can be accurately located in real-time, facilitating compliance with regulations that mandate location verification for emergency services and lawful intercepts.

### TECHNICAL FIELD

The present application pertains to the technical field of telecommunications and regulatory compliance in Internet-based or network-based communication systems. More specifically, the present application involves techniques for enabling the use of telephone numbers on devices that provide Over-the-Top communication services, such as voice over Internet protocol (VOIP) services, using a network such as the Internet, while ensuring real-time location verification of the user in accordance with jurisdictional regulatory requirements.

### BACKGROUND

Over-the-Top (OTT) communication services represent a significant advancement in the field of telecommunications, offering a versatile and cost-effective alternative to traditional telecommunication services. These OTT services enable voice, text, and multimedia communications over the Internet, bypassing the conventional public switched telephone network (PSTN) and mobile networks. One example of OTT communication technology is VOIP, which allows users to make voice calls using a broadband network (e.g., Internet) connection instead of a regular phone line. One of the features of OTT services is the ability for users to maintain a single telephone number across multiple devices, including smartphones, tablets, and computers, enhancing accessibility and convenience.

The proliferation of OTT services has led to several advantages for consumers and businesses alike. Firstly, OTT platforms often provide significant cost savings, as they typically require only an Internet connection, reducing or eliminating the need for expensive voice plans and long-distance charges associated with traditional telephony. Secondly, OTT services offer increased flexibility, as users are not tethered to a single location or device; they can access their communication services from anywhere with a broadband network connection. Lastly, these services have fostered much innovation in communication technologies, as they allow for rapid integration of additional features such as video calling, real-time messaging, and file sharing, which are not inherently available through traditional telephony systems. These advantages have contributed to the widespread adoption and continuous growth of OTT communication services in the global market.

### BRIEF DESCRIPTION OF THE DRAWINGS

Embodiments of the present invention are illustrated by way of example and not limitation in the figures of the accompanying drawings, in which:

FIG. 1 is a diagram illustrating a network environment in which various embodiments of the present invention may be implemented.

FIG. 2 is a diagram illustrating a network environment including a first computing device, “bound” with a mobile device via a local “proximity” network, such that a user of the communication application is permitted to initiate and receive network-based telephone calls via the communication application when state information of the mobile device satisfies specific conditions, according to some examples.

FIG. 3 is a flow diagram illustrating an example of a first method for enabling a first device to initiate a network-based outbound telephone call via a first communication application based on status information of a mobile device in proximity with the first device, consistent with some embodiments.

FIG. 4 is a flow diagram illustrating an example of a second method for enabling a first device to initiate a network-based outbound telephone call via a first communication application based on status information of a mobile device in proximity with the first device, consistent with some embodiments.

FIG. 5 is a block diagram illustrating a software architecture, which can be installed on any of a variety of computing devices to perform methods consistent with those described herein.

FIG. 6 is a diagrammatic representation of a machine in the form of a computer system (e.g., a server computer) within which a set of instructions may be executed for causing the machine to perform any one or more of the methodologies discussed herein, according to an example embodiment.

### DETAILED DESCRIPTION

Described herein are techniques for enabling software-based communication services on devices without cellular or mobile network connectivity to utilize telephone numbers, including Mobile Telephone Numbers (MTNs) and other phone number types, in compliance with jurisdictional regulatory requirements. More specifically, the present disclosure describes a method for binding such non-mobile devices to a mobile device that is capable of generating and providing real-time location information, thereby allowing a non-mobile device to place and receive calls while adhering to regulations that mandate the availability and reporting of location verification. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

In various jurisdictions around the world, government regulations impose specific requirements on the use of telephone numbers when utilized in conjunction with software-based communication services, including Voice over Internet Protocol (VOIP). In some cases, the regulations apply to any telephone number, whereas in other instances, regulations may be specific to telephone numbers that fall within some predetermined range or are otherwise dedicated as being a specific type of telephone number, to include as an example, Mobile Telephone Numbers. These regulations often mandate that the location of a user, using a specific telephone number, be verifiable in real-time when a telephone call is placed. The intent behind such regulations is typically to ensure that emergency services can accurately locate the caller, as well as to facilitate lawful intercepts and other security measures. However, these requirements present technical challenges for devices that rely on Internet-based communications, such as VoIP services, which traditionally do not have a direct association with a cellular network or mobile network and therefore cannot inherently establish and provide verifiable location information.

The challenge is particularly pronounced for devices that lack a SIM or eSIM and are thus inherently incapable of connecting to a mobile network, such as most desktop computers, laptops, and many tablets. These devices, while capable of running VoIP applications and making calls over the Internet, do not have the means to report their location through the cellular network or mobile network infrastructure. As a result, in jurisdictions with stringent regulations, the use of MTNs or other regulated number types with such devices for VOIP calling is restricted or prohibited. This limitation not only hinders the flexibility and convenience of using Internet-based services, such as VoIP services, but also impacts the adoption of unified communications platforms that are increasingly prevalent in both business and personal contexts.

To address technical issues at which these regulatory constraints are aimed, there is a need for a technical solution that enables devices that are not equipped with a SIM card or eSIM, and thus do not have native cellular or mobile connectivity, to comply with the location verification and reporting requirements as set forth by local regulations. As described herein, embodiments of the present invention provide such a solution. Consistent with some examples, a non-mobile device is at least temporarily associated with a mobile device that can provide the necessary location information. This establishment of a temporary association is referred to herein as a “binding” of the devices. In the context of the present application, “binding” refers to the process of creating a temporary but secure association between a non-mobile device, such as a desktop computer, laptop, or tablet, and a mobile device, such as a smartphone, that has native cellular or mobile connectivity. This binding is established to allow the non-mobile device to use the mobile device's ability to establish and provide real-time location information, which is necessary to comply with certain regulatory requirements that mandate location verification for telecommunication services.

Consistent with some embodiments, the establishment of a connection between a mobile device and a non-mobile device-referred to herein as “binding”—is accomplished through a proximity network. A proximity network connection utilizes short-range wireless networking technologies or protocols, such as Bluetooth Low Energy (BTLE), Wi-Fi Direct, or comparable communication methods. The term “proximity network connection” is used to denote this type of short-range wireless network connection because it is predicated on the physical closeness of the devices. The proximity network connection ensures that the non-mobile device is within a certain range of the mobile device, which allows the system to deduce that the location information provided by the mobile device is applicable and accurate for the non-mobile device as well. This proximity is important for the system's ability to meet regulatory requirements that necessitate the verification of a user's location for certain telecommunication services.

Furthermore, within this binding relationship, the mobile device acts as the controlling device. This means that the mobile device is responsible for providing state or status information of the mobile device, including for example the status of its network connectivity and in some instances its location information specifically. In some instances, the status information of the mobile device may be provided directly to the non-mobile device, and the logic of the communication application executing on the non-mobile device determines whether outbound calls are allowed or blocked, based on the received status information of the mobile device. In other examples, the status information of the mobile device is provided by the mobile device to a cloud-based communications service, such that the cloud-based communications service can determine whether to allow or block calls initiated from the communications application of the non-mobile device, based on the status information reported to the cloud-based communications service by the mobile device. Accordingly, the communications service relies on this information to make decisions about initiating and maintaining communication services, such as VoIP calls. The control exerted by the mobile device ensures that the non-mobile device's use of telecommunication services remains in compliance with the regulatory requirements, as the ability to place calls is contingent upon the mobile device's confirmation of a mobile network connection and its ability to verify and confirm location information.

In the context of the disclosure, a “network-based” call refers to a voice communication that is conducted over a network, such as the Internet, using data packets, rather than through traditional circuit-switched telephone networks. This type of call is facilitated by OTT communication services, such as VoIP, which allow the non-mobile device to make and receive telephone calls using an Internet connection. The important distinction here is that while the non-mobile device is bound to a mobile device through a local proximity network using short-range wireless communication protocols, the actual call does not traverse this proximity network. Instead, the call is directly routed through a public network connection, such as the Internet, which is separate and distinct from the wireless network connecting the non-mobile and mobile devices. This ensures that the call's integrity and compliance with regulatory requirements are maintained, as the call's routing through the public network allows for the necessary location verification and other regulatory compliances.

In order to facilitate compliance with regulatory requirements, the mobile device and the non-mobile device engage in data exchange to ensure that accurate call detail records (CDRs) can be established. These call detail records are used to document the details of each call made using the system, including the telephone number used to invoke the Internet-based call, the duration of the call, and in some instances, the location of the devices at the time of the call. The exchange of data between the devices allows for the creation of CDRs that are not only comprehensive but also compliant with the legal standards set forth by various jurisdictions.

The process of data exchange for CDRs is twofold. Firstly, during the establishment of a call, the non-mobile device may receive from the mobile device information such as the current connectivity status and location data. This information is then used by the non-mobile device to populate a CDR with the necessary details that reflect the call's compliance with location verification mandates. Secondly, in some embodiments, the mobile device may also transmit call-related information directly to the operator of the mobile network. This allows the mobile network operator to maintain their own set of CDRs, which may be required for billing purposes, regulatory compliance, or law enforcement requests.

The CDRs maintained by the mobile network operator and the non-mobile device may vary in the level of detail they contain. For instance, the operator's CDRs typically include the mobile device's telephone number, the time and date of the call, and the location of the mobile device as determined by its connection to the mobile network. On the other hand, the CDRs on the non-mobile device may additionally include the telephone number used for the Internet-based call, which could be different from the number associated with the mobile device. This level of detail ensures that the system can provide a comprehensive audit trail for each call, satisfying the regulatory requirements for real-time location verification and enabling the provision of emergency services when necessary. Other aspects and advantages of various embodiments of the present invention are set forth below in the description of the several figures that follow.

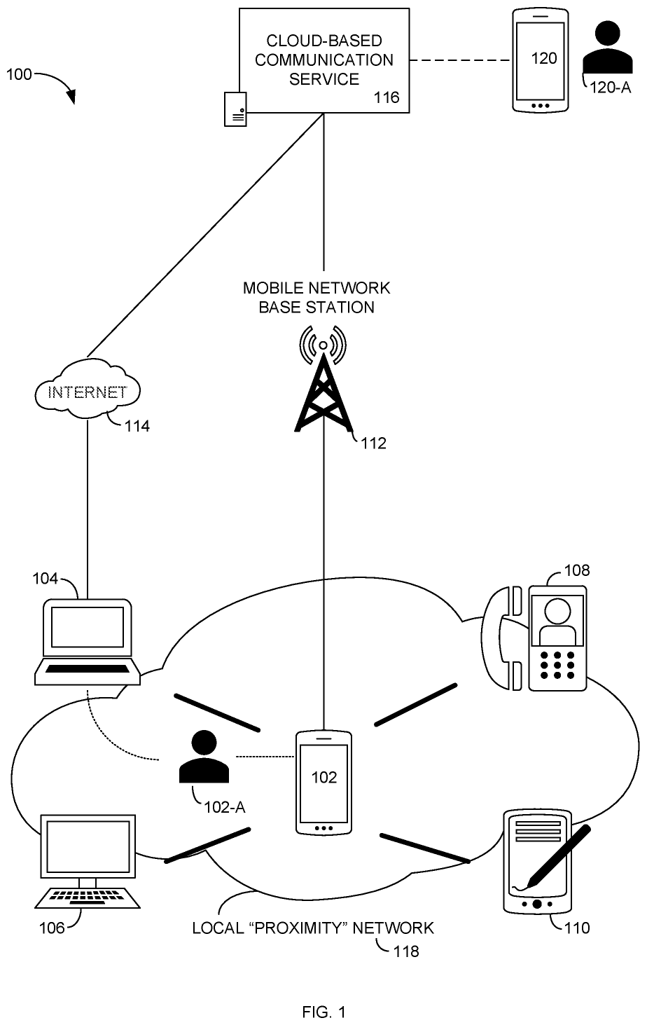

FIG. 1 is a diagram illustrating a network environment 100 in which various embodiments of the present invention may be implemented. In this environment, a user 102-A is in possession of a mobile computing device 102. The mobile computing device 102 may be a smartphone or similar and is equipped with either a SIM card and/or eSIM, enabling it to establish a connection with the mobile network of a mobile network operator. This connection is depicted in FIG. 1 by a line linking the mobile device 102 to a mobile network base station 112, representing the infrastructure of the mobile network.

When the mobile device 102 is actively connected to the mobile network base station 112, the mobile device 102 and the mobile network are capable of determining the location of the mobile device 102. Although the exact location of the mobile device 102 may not be pinpointed precisely, an estimated location can be derived based on the known location of the base station 112 and the maximum range at which the mobile device 102 can maintain a connection with the base station. This estimation leverages the fact that the mobile device's ability to connect to the network is limited by the distance from the base station.

In a typical use case, the mobile device 102 may not be limited to a single connection but may instead establish connections with multiple base stations within the mobile network. This multipoint connectivity allows for more refined location information to be calculated using triangulation techniques. By measuring the signal strength and timing from multiple base stations to the mobile device 102, the network can triangulate the position of the device, resulting in a more accurate estimation of the user's location.

Additionally, the mobile device 102 may be equipped with a GPS receiver, which can obtain GPS signals to determine precise location information. The integration of GPS technology allows the device to pinpoint its geographic location by communicating with a constellation of satellites, providing another layer of location accuracy that is particularly useful when the device is outdoors and has a clear line of sight to the sky.

Beyond the mobile network and GPS, the mobile device 102 can also utilize other wireless networks, such as Wi-Fi networks, to assist in establishing its location. Wi-Fi networks, often characterized by their shorter range and high density in urban environments, can offer additional data points for location determination. By identifying nearby Wi-Fi networks and measuring signal strength, the mobile device 102 can further refine its estimated location, which can be especially valuable when the device is indoors or in areas where GPS signals are obstructed.

In the depicted network environment 100, the mobile device 102 is also capable of creating a local proximity network 118 by establishing a connection with one or more non-mobile devices, such as the laptop 104, desktop 106, desk phone 108, and tablet 110. A non-mobile device, in this context, refers to any computing device that lacks a SIM or eSIM and is therefore unable to establish a wireless network connection, such as a cellular connection, with a mobile network operator. Examples of non-mobile devices include desktop computers, laptops, tablets, and other similar devices that typically rely on fixed network connections or short-range wireless connections for Internet access.

The formation of the proximity network 118 is facilitated through the use of short-range wireless network protocols. These protocols are designed to enable communication over limited distances and include technologies such as Bluetooth, Bluetooth Low Energy (BTLE), Wi-Fi Direct, Near Field Communication (NFC), and other similar protocols. Each of these technologies has its own set of characteristics and use cases, but they all serve the purpose of allowing the mobile device 102 to communicate with nearby non-mobile devices within the proximity network.

The radio signals employed by these short-range wireless network protocols are of a frequency that inherently limits the distance over which a reliable connection can be maintained. Typically, the maximum range for these connections is approximately 1000 meters, although this can vary based on environmental factors, the specific technology used, and the power of the transmission. This characteristic of short-range wireless technologies ensures that any two devices within the proximity network 118 are within a defined spatial range, reinforcing the concept of proximity and enabling the system to make assumptions about the relative location of the devices within the network.

Within the network environment illustrated in FIG. 1, each device that is part of the proximity network 118 has installed thereon a communications application. This application is a component of a service offering provided by a cloud-based communications service provider 116. The communications application is sophisticated software that enables a multitude of communication functions, including voice, video, messaging, and file sharing, across various devices within the proximity network.

In some embodiments, it is the communications application itself that orchestrates the formation of the proximity network 118 by instructing each device to join. While the application provides the high-level commands for network formation, the actual establishment of the network typically relies on lower-level operating system (OS) instructions and the inherent capabilities of the device's hardware. The communications application acts as a facilitator, leveraging the underlying OS and hardware features to create a seamless user experience within the unified communications framework.

The connections between devices in the proximity network 118 are established conditionally, based on the user's logged-in status within the communications application on each device. This ensures that the network is secure and that communication is only enabled between devices authorized by the user. Technically, this can be achieved through authentication protocols where the communications application on each device communicates with a central server to verify the user's credentials. Once authenticated, the server signals the devices to proceed with establishing the proximity network.

In this example, the mobile device 102 serves as the controller device within the proximity network. As the controller, the mobile device 102 manages the network by maintaining a list of connected devices, managing the exchange of security keys for encryption, and coordinating the network's overall activities. The mobile device 102 ensures that only devices logged into the user's account via the communications application can join the network. This is typically achieved through a combination of secure authentication and session management techniques, where the mobile device 102 validates the presence and credentials of other devices before allowing them to participate in the proximity network. The communications application on the mobile device 102 may display a user interface allowing the user to manage connections, view connected devices, and control access to the network, thus maintaining the integrity and security of the communications within the proximity network.

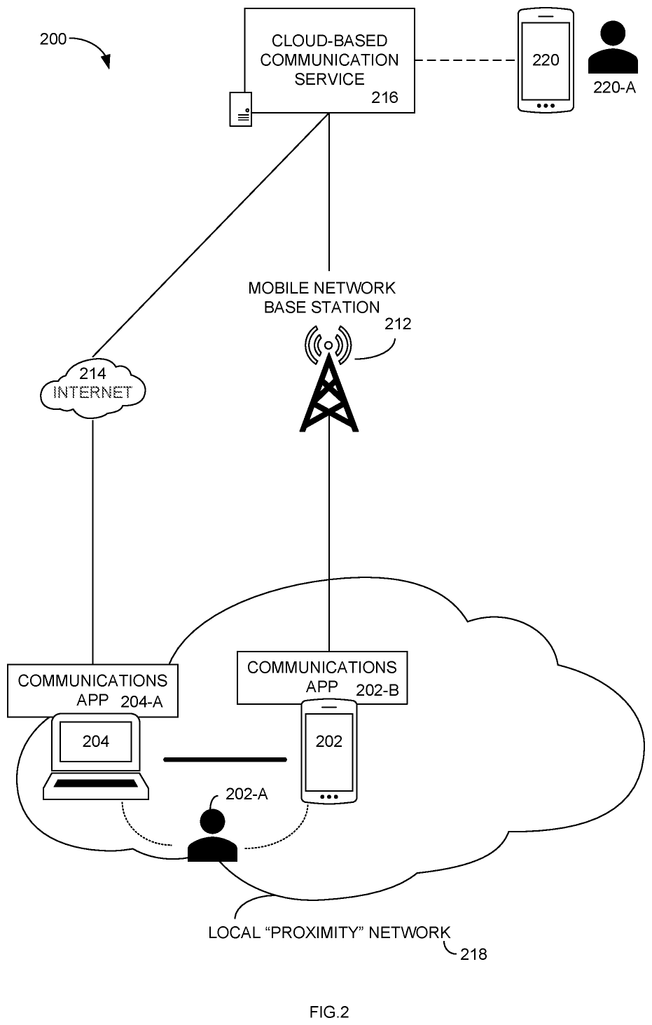

During the system's operation, when a user attempts to initiate or receive a call, the non-mobile device first verifies the status of the mobile device 102, which acts as the controlling device within the proximity network 118. This verification process involves checking whether the mobile device 102 is in an active state, signifying its connection to the cellular network and its ability to provide real-time location data. Of course, it is also necessary for the non-mobile device to have a connection with the mobile device via a local proximity network. If the mobile device 102 meets the necessary conditions, indicating that it is within range and properly connected, the non-mobile device is then permitted to proceed with the call. In certain scenarios, the responsibility for verifying the status of the mobile device 102 may shift from the non-mobile device to the cloud-based communications service. In these instances, it is the cloud-based communications service that determines the eligibility of the non-mobile devices to place or receive calls based on the real-time status information received from the mobile device 102. This ensures that the system adheres to regulatory requirements and maintains the integrity of the communication services. The specifics of how the non-mobile device and the cloud-based communications service interact to facilitate call authorization are further elaborated in the description of FIG. 2, which provides a detailed account of the operational flow and the conditions under which calls are allowed or inhibited within the network.

FIG. 2 is a diagram illustrating a network environment including a first computing device, “bound” with a mobile device via a local “proximity” network, such that a user of the communication application is permitted to initiate and receive Internet-based telephone calls via the communication application when state information of the mobile device satisfies specific conditions, according to some examples.

In a first embodiment, the non-mobile device 204, which is shown in FIG. 2 to be a laptop, but in alternative embodiments could be any of a wide variety of other devices, establishes a local proximity network 218 with the mobile device 202. This local proximity network 218 is facilitated by a local wireless connection using technologies such as Bluetooth Low Energy (BTLE) or Wi-Fi Direct, which are designed to operate over short distances, ensuring that the devices are within a certain physical range of each other. The establishment of this network allows for the binding process, which ties the capabilities of the mobile device 202 to the non-mobile device 204. Specifically, the non-mobile device 204 is allowed to use as a proxy the location of the mobile device 202.

Once the local proximity network 218 is established, and the mobile device 202 is connected to the mobile network base station 212, the mobile device 202 begins to report its status information directly to the non-mobile device 204. This status information includes, but is not limited to, the connectivity status of the mobile device 202 with the mobile network and its current location data. The communications application 204-A installed on the non-mobile device 204 is then responsible for verifying this status information. Upon successful verification that the mobile device 202 is indeed connected to the base station 212 and is within the required proximity, the communications application 204-A enables the non-mobile device 204 to initiate or receive calls.

In certain embodiments, the control device, such as the mobile device 202, takes the initiative to establish the local proximity network 218. It then commences the transmission of its status information to the non-mobile device 204. This proactive approach by the mobile device 202 ensures that the non-mobile device 204 is immediately aware of the mobile device's network connectivity and location status, which is crucial for the authorization of call activities. The communications application 204-A on the non-mobile device 204 relies on this information to validate the conditions for call initiation and reception are met, based on the real-time status provided by the mobile device 202.

Conversely, in other embodiments, the non-mobile device, such as a laptop 204, may be tasked with establishing the proximity network 218 and actively requesting the status information from the mobile device 202. This scenario places the onus on the non-mobile device 204 to seek out and confirm the operational status of the mobile device 202, ensuring that it is in a state that complies with the regulatory requirements for call handling. Regardless of which device initiates the network establishment and status information exchange, the system is designed to maintain continuous updates of the status information. This allows for real-time monitoring and immediate response to any changes in state. For example, if the mobile device 202 were to disconnect from the base station 212 or move out of the proximity network's range, it would promptly communicate this change in status to the non-mobile device 204, triggering appropriate measures such as call inhibition to maintain compliance with the established communication protocols.

An example of this operation could be a user with a laptop (non-mobile device 204) in a coffee shop attempting to place a call, via the internet 214, through the communications application 204-A. The user's mobile device 202, which is on the same table, is connected to the local cellular network's base station 212. The laptop, through the communications application 204-A, checks the status of the mobile device 202 and confirms that it is connected and within range. The call is then allowed to proceed, with the laptop leveraging the mobile device's network connection status and location information to comply with regulatory requirements.

Alternatively, the status information of the mobile device 202 may be reported to the cloud-based communication service 216, for example, via the Internet 214 or the Mobile network (e.g., via mobile network base station 212). In this scenario, the cloud-based communication service 216 acts as the gatekeeper, enforcing the rules that allow or disallow calls to and from the non-mobile device 204. The cloud-based service 216 receives the status information from the mobile device 202, which includes its network connectivity and location status. The service 216 then uses this information to determine whether the non-mobile device 204 is authorized to make or receive a call.

For instance, if the mobile device 202 loses connectivity with the base station 212 or moves out of the proximity network's range, the cloud-based communication service 216 would receive this updated status information. The service 216 could then immediately inhibit any ongoing or attempted calls from the non-mobile device 204, ensuring compliance with the necessary regulatory conditions. This mechanism ensures that the non-mobile device 204 can only operate within the bounds of the established rules, maintaining the integrity of the communication system and adhering to jurisdictional regulations.

When a call is initiated or received by the non-mobile device 204, the communications application 204-A may engage in a data exchange with the mobile device 202 to obtain the necessary status information, including location data. This information is then used to populate the CDR with the required details. The CDRs are designed to reflect the call's compliance with location verification mandates, ensuring that the system can provide a comprehensive audit trail for each call. This satisfies the regulatory requirements for real-time location verification and enables the provision of emergency services when necessary.

In addition to the CDRs maintained on the non-mobile device 204, the mobile device 202 may also transmit call-related information directly to the operator of the mobile network. This allows the mobile network operator to maintain their own set of CDRs, which may be required for billing purposes, regulatory compliance, or law enforcement requests. The CDRs maintained by the mobile network operator typically include the mobile device's telephone number, the time and date of the call, and the location of the mobile device as determined by its connection to the mobile network.

Regarding lawful intercepts, a regulatory authority could register a request with the mobile network operator to monitor the communications of a specific number. The system is designed to facilitate such intercepts by ensuring that the mobile device 202 can provide real-time location data and other relevant call details to the operator. When a lawful intercept is registered, the mobile network operator can access the CDRs and provide the necessary information to the regulatory authority without needing to involve the cloud-based communication service 216 or the non-mobile device 204. This process is handled discreetly and securely, in compliance with legal standards and without compromising the privacy and security of the communication network.

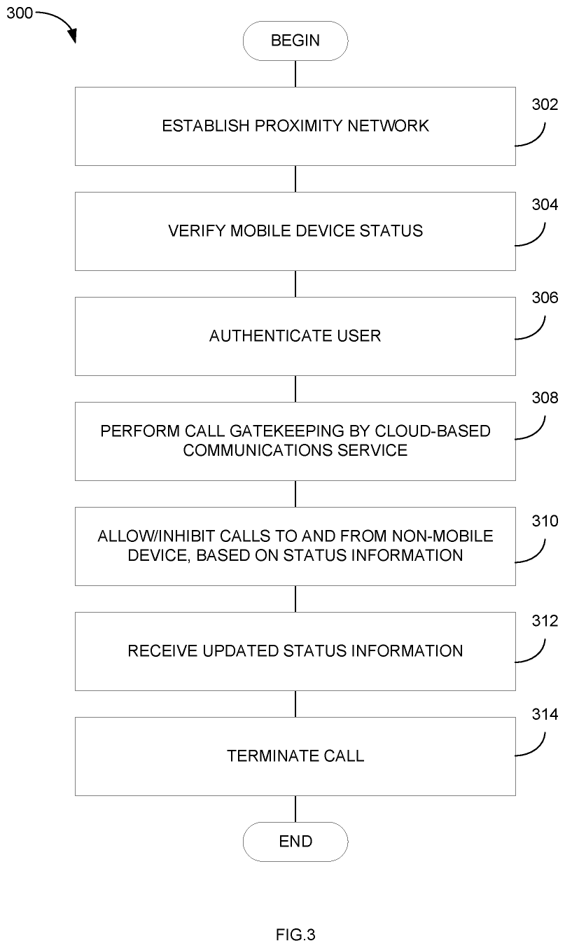

FIG. 3 is a flow diagram illustrating an example of a first method 300 for enabling a first device to initiate an Internet-based outbound telephone call via a first communication application based on status information of a mobile device in proximity with the first device, consistent with some embodiments. The method begins, at 302, with the establishment of a local proximity network between the mobile device and the non-mobile device. This network is created using short-range wireless communication protocols such as Bluetooth Low Energy (BTLE) or Wi-Fi Direct. The proximity network ensures that the devices are within a defined spatial range, which is essential for the binding process and subsequent steps.

Once the proximity network is in place, at 304, the mobile device reports its status information to the cloud-based communications service. This information includes the mobile device's connectivity status with the mobile network and its current location data. The cloud-based service uses this information to verify the mobile device's eligibility to facilitate calls.

Concurrently, at 306, the system authenticates the user's presence on both the mobile and non-mobile devices. This step ensures that the user attempting to make or receive a call is the same across both devices, thereby maintaining the security and integrity of the communication process.

At 308, the cloud-based communications service acts as a gatekeeper, analyzing the status information provided by the mobile device. This analysis determines whether the conditions for initiating a call are met, which includes verifying the mobile device's active connection to the mobile network and its proximity to the non-mobile device.

At 310, based on the cloud-based service's evaluation, it either allows or inhibits the non-mobile device from making or receiving an Internet-based call. If the mobile device's status satisfies the specific conditions, the non-mobile device is permitted to proceed with the call.

During the call, at 312, the mobile device continuously updates its status information to the cloud-based communications service. This real-time monitoring allows for maintaining compliance with regulatory requirements and ensuring the call's integrity.

If at any point during the call the mobile device's status changes unfavorably, such as losing connectivity to the mobile network or moving out of the proximity network's range, the cloud-based communications service responds by terminating the call, as illustrated with reference 314. This immediate action is taken to adhere to the regulatory conditions and to ensure the user's location can be verified throughout the call duration.

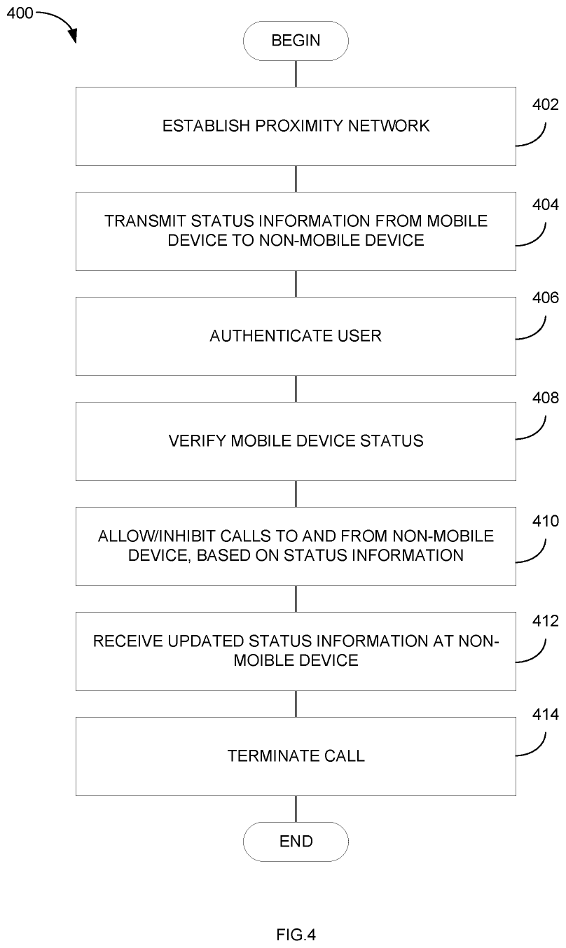

FIG. 4 is a flow diagram illustrating an example of a second method 400 for enabling a first device to initiate an Internet-based outbound telephone call via a first communication application based on status information of a mobile device in proximity with the first device, consistent with some embodiments. The process begins, at 402, with the non-mobile device, such as a laptop or tablet, establishing a local proximity network with the mobile device. This network is created using short-range wireless communication protocols, ensuring that the devices are within a certain physical range necessary for secure communication.

Following the establishment of the proximity network, at 404, the mobile device transmits its status information, which includes its connectivity status with the mobile network and its current location data, directly to the non-mobile device. This direct communication ensures that the non-mobile device has immediate access to the necessary information to enforce call rules.

Before a call is placed, at 406, user authentication is also performed to ensure that the same user is logged into their account on both the mobile device and the non-mobile device. This step allows for maintaining the security and integrity of the communication process.

The non-mobile device, equipped with a communications application, is responsible for verifying the status information received from the mobile device, which occurs at step 408. This verification step ensures that the mobile device is in compliance with the required conditions for call initiation, such as being actively connected to the mobile network and within the proximity network's range.

The non-mobile device then, at 410, acts as the gatekeeper, using the verified status information to determine whether to allow or inhibit the initiation of an Internet-based call. If the mobile device's status meets the necessary criteria, the non-mobile device enables call functionality.

During an active call, at 412, the non-mobile device continuously monitors the status information from the mobile device. This ongoing monitoring ensures that the call remains compliant with regulatory requirements throughout its duration.

Should there be any change in the status information that indicates the mobile device is no longer connected to the mobile network or has moved out of the proximity network's range, the non-mobile device is programmed to terminate the call, for example, at 414. This immediate action is taken to adhere to the regulatory conditions and to ensure the user's location can be verified at all times during the call.

### Machine and Software Architecture

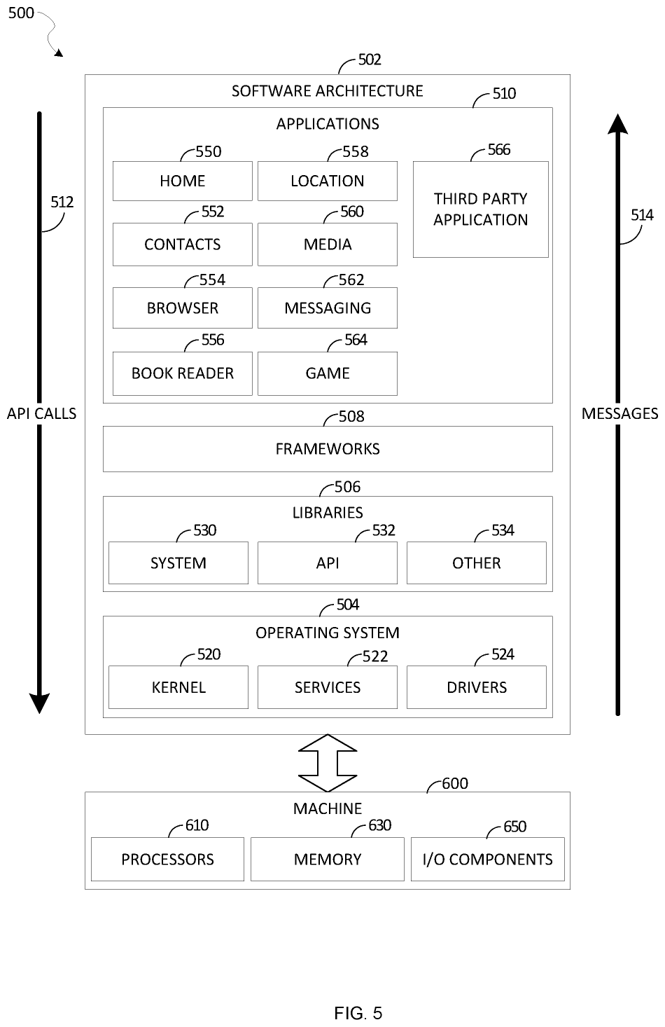

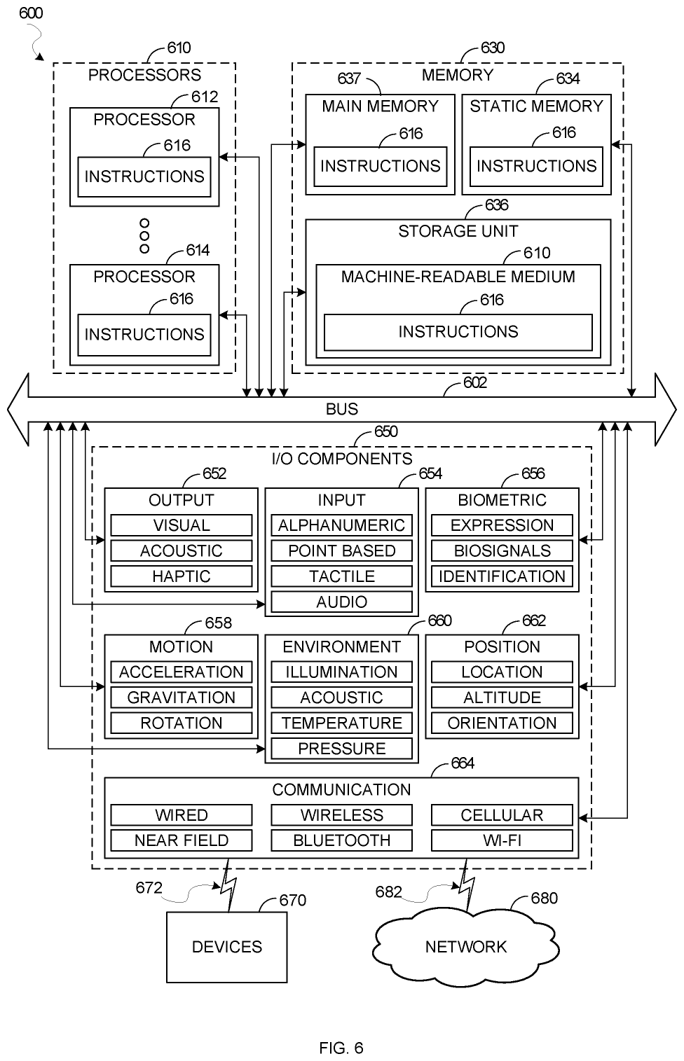

FIG. 5 is a block diagram 500 illustrating a software architecture 502, which can be installed on any of a variety of computing devices to perform methods consistent with those described herein. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 602 includes layers such as an operating system 504, libraries 506, frameworks 508, and applications 510. Operationally, the applications 510 invoke API calls 512 through the software stack and receive messages 514 in response to the API calls 512, consistent with some embodiments.

In various embodiments, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 can also include a wide variety of other libraries 634 to provide many other APIs to the applications 510.

The frameworks 508 provide a high-level common infrastructure that can be utilized by the applications 510, according to some embodiments. For example, the frameworks 508 provide various GUI functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 512 provided by the operating system 504 to facilitate functionality described herein.

FIG. 6 illustrates a diagrammatic representation of a machine 600 in the form of a computer system within which a set of instructions may be executed for causing the machine to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example the instructions 616 may cause the machine 600 to execute any one of the methods or algorithmic techniques described herein. Additionally, or alternatively, the instructions 616 may implement any one of the systems described herein. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 916 to perform any one or more of the methodologies discussed herein.

The machine 600 may include processors 610, memory 630, and I/O components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions contemporaneously. Although FIG. 6 shows multiple processors 610, the machine 600 may include a single processor with a single core, a single processor with multiple cores (e.g., a multi-core processor), multiple processors with a single core, multiple processors with multiples cores, or any combination thereof.

The memory 630 may include a main memory 632, a static memory 634, and a storage unit 636, all accessible to the processors 610 such as via the bus 602. The main memory 630, the static memory 634, and storage unit 636 store the instructions 616 embodying any one or more of the methodologies or functions described herein. The instructions 916 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile devices will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a USB).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 630, 632, 634, and/or memory of the processor(s) 610) and/or storage unit 636 may store one or more sets of instructions and data structures (e.g., software) embodying or utilized by any one or more of the methodologies or functions described herein. These instructions (e.g., the instructions 616), when executed by processor(s) 610, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 680 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

We claim:

1. A computer-implemented method for enabling a first device to initiate a network-based outbound telephone call via a first communication application based on status information of a mobile phone in proximity with the first device, the computer-implemented method comprising:
establishing a first network connection between the first device and the mobile phone, the first network connecting being a wireless network connection established using a short-range wireless communication protocol;
causing a second communication application executing on the mobile phone to share status information of the mobile phone with the first device or with a cloud-based communications service, the status information indicating whether the mobile phone is connected with a mobile network;
receiving at the first communication application of the first device a request to initiate the network-based outbound telephone call;
in response to determining that the status information of the mobile phone indicates that the mobile phone is connected with the mobile network, initiating the network-based telephone call through a second network connection distinct from the first network connection; and
in response to determining that either the status information of the mobile phone indicates that the mobile phone is not connected with the mobile network, or the first device cannot determine the presence of or cannot establish a connection with the mobile phone, inhibiting the network-based telephone call.

2. The computer-implemented method of claim 1, wherein causing the second communication application to share status information of the mobile phone comprises:
transmitting, by the second communication application executing on the mobile phone, the status information to a cloud-based communications service, the status information comprising data indicative of the connectivity status of the mobile phone with the mobile network and the existence of the first network connection between the first device and the mobile phone;
wherein the cloud-based communications service is configured with logic to either permit or inhibit the initiation of the network-based telephone call by the first communication application of the first device, based upon the analysis of the received status information from the mobile phone.

3. The computer-implemented method of claim 2, wherein determining that the status information of the mobile phone indicates that the mobile phone is connected with the mobile network comprises:
receiving, from the first communication application at the first device, at the cloud-based communications service, the request to initiate the network-based outbound telephone call; and
performing a verification of the status information of the mobile phone as transmitted by the second communication application executing on the mobile phone to the cloud-based communications service to determine that the status information of the mobile phone indicates that the mobile phone is connected with the mobile network.

4. The computer-implemented method of claim 3, wherein the status information of the mobile phone indicates a known location state for the mobile phone in addition to indicating that the mobile phone is connected with a mobile network, the known location state for the mobile phone based on the mobile phone determining a location of the mobile phone, by:
determining, by the mobile phone, the location of the mobile phone based on the location of one or more base stations to which the mobile phone is connected within the mobile network; or
acquiring, by a GPS component of the mobile phone, GPS data indicative of a geographic location of the mobile phone.

5. The computer-implemented method of claim 1, wherein providing the status information of the mobile phone comprises:
transmitting, by the second communication application executing on the mobile phone, the status information of the mobile phone to the first communication application executing on the first device via the established wireless network connection, the status information of the mobile phone comprising data indicating a connectivity status of the mobile phone with the mobile network;
wherein determining that the status information of the mobile phone indicates that the mobile phone is connected with the mobile network comprises: performing a verification of the status information of the mobile phone.

6. The computer-implemented method of claim 5, wherein providing the status information comprises transmitting the status information to the first device over the established wireless network connection;
wherein determining that the status information of the mobile phone indicates that the mobile phone is connected with the mobile network is performed by the first communication application at the first device by checking the status information received over the wireless network connection prior to initiating the network-based outbound telephone call.

7. The computer-implemented method of claim 6, wherein the status information of the mobile phone indicates a known location state for the mobile phone in addition to indicating that the mobile phone is connected with a mobile network, the known location state for the mobile phone based on the mobile phone determining a location of the mobile phone, by:
determining, by the mobile phone, the location of the mobile phone based on the location of one or more base stations to which the mobile phone is connected within the mobile network; or
acquiring, by a GPS component of the mobile phone, GPS data indicative of a geographic location of the mobile phone.

8. The computer-implemented method of claim 1, wherein the status information additionally indicates that a user is concurrently logged into a single user account from both the first communication application on the first device and the second communication application on the mobile phone, the method further comprising:
verifying, by the first communication application on the first device, that the user is logged into the single user account on both the first device and the mobile phone based on the status information provided by the second communication application; and
conditioning the initiation of the network-based outbound telephone call on the verification that the user is logged into the single user account on both devices.

9. The computer-implemented method of claim 1, wherein the status information of the mobile phone is continuously updated during the duration of an ongoing telephone call, the method further comprising:
monitoring, by the first communication application on the first device, for any changes in the continuously updated status information provided by the second communication application on the mobile phone;
determining, by the first communication application on the first device, a change in the status information indicating that the mobile phone is no longer connected to the mobile network or that the mobile phone is no longer in wireless network connection with the first device; and
terminating the ongoing call by the first communication application on the first device in response to the determination that the mobile phone is no longer connected to the mobile network or is no longer in wireless network connection with the first device.

10. A system for enabling a first device to initiate a network-based outbound telephone call via a first communication application based on status information of a mobile phone in proximity with the first device, the system comprising:
one or more processors;
a memory storage device storing instructions thereon, which, when executed by the one or more processors, cause the system to perform method operations comprising:
establishing a first network connection between the first device and the mobile phone using a short-range wireless communication protocol;
causing a second communication application executing on the mobile phone to share status information with the first device or with a cloud-based communications service, the status information indicating whether the mobile phone is connected with a mobile network;
receiving at the first communication application of the first device a request to initiate the network-based outbound telephone call;
initiating the network-based telephone call through a second network connection distinct from the first network connection in response to a determination that the status information indicates that the mobile phone is connected with the mobile network; and
inhibiting the network-based telephone call in response to a determination that either the status information indicates that the mobile phone is not connected with the mobile network, or the first device cannot determine the presence of or cannot establish a connection with the mobile phone.

11. The system of claim 10, wherein the memory storage device further stores instructions that, when executed by the one or more processors, cause the system to perform method operations comprising:
transmitting the status information from the mobile phone to a cloud-based communications service, the status information comprising data indicative of the connectivity status of the mobile phone with the mobile network and the existence of the first network connection between the first device and the mobile phone;
wherein the cloud-based communications service includes logic to either permit or inhibit the initiation of the network-based telephone call by the first communication application of the first device, based upon the analysis of the received status information from the mobile phone.

12. The system of claim 11, wherein the memory storage device further stores instructions that, when executed by the one or more processors, cause the system to perform method operations comprising:
receiving, at the cloud-based communications service, the request to initiate the network-based outbound telephone call from the first communication application at the first device; and
performing a verification of the status information of the mobile phone to determine that the status information indicates that the mobile phone is connected with the mobile network.

13. The system of claim 12, wherein the status information of the mobile phone further indicates a known location state for the mobile phone based on the mobile phone determining a location of the mobile phone, by:
determining the location of the mobile phone based on the location of one or more base stations to which the mobile phone is connected within the mobile network; or
acquiring GPS data indicative of a geographic location of the mobile phone by a GPS component of the mobile phone.

14. The system of claim 10, wherein the memory storage device further stores instructions that, when executed by the one or more processors, cause the system to perform method operations comprising:
transmitting the status information from the mobile phone to the first communication application executing on the first device via the established wireless network connection, the status information comprising data indicating a connectivity status of the mobile phone with the mobile network;
wherein the first communication application at the first device performs a verification of the status information of the mobile phone.

15. The system of claim 14, wherein the memory storage device further stores instructions that, when executed by the one or more processors, cause the system to perform method operations comprising:
transmitting the status information to the first device over the established wireless network connection;
wherein the first communication application at the first device checks the status information received over the wireless network connection prior to initiating the network-based outbound telephone call.

16. The system of claim 15, wherein the status information of the mobile phone further indicates a known location state for the mobile phone based on the mobile phone determining a location of the mobile phone, by:
determining the location of the mobile phone based on the location of one or more base stations to which the mobile phone is connected within the mobile network; or
acquiring GPS data indicative of a geographic location of the mobile phone by a GPS component of the mobile phone.

17. The system of claim 10, wherein the memory storage device further stores instructions that, when executed by the one or more processors, cause the system to perform method operations comprising:
verifying that a user is concurrently logged into a single user account from both the first communication application on the first device and the second communication application on the mobile phone based on the status information provided by the second communication application; and
conditioning the initiation of the network-based outbound telephone call on the verification that the user is logged into the single user account on both devices.

18. The system of claim 10, wherein the memory storage device further stores instructions that, when executed by the one or more processors, cause the system to perform method operations comprising:
continuously updating the status information of the mobile phone during the duration of an ongoing telephone call;
monitoring for any changes in the continuously updated status information provided by the second communication application on the mobile phone;
determining a change in the status information indicating that the mobile phone is no longer connected to the mobile network or that the mobile phone is no longer in wireless network connection with the first device; and
terminating the ongoing call in response to the determination that the mobile phone is no longer connected to the mobile network or is no longer in wireless network connection with the first device.

19. A machine-readable medium storing instructions thereon, which, when executed by one or more processors, cause a machine to perform operations comprising:
establishing a first network connection between the first device and the mobile phone using a short-range wireless communication protocol;
causing a second communication application executing on the mobile phone to share status information with the first device or with a cloud-based communications service, the status information indicating whether the mobile phone is connected with a mobile network;
receiving at the first communication application of the first device a request to initiate the network-based outbound telephone call;
initiating the network-based telephone call through a second network connection distinct from the first network connection in response to a determination that the status information indicates that the mobile phone is connected with the mobile network; and
inhibiting the network-based telephone call in response to a determination that either the status information indicates that the mobile phone is not connected with the mobile network, or the first device cannot determine the presence of or cannot establish a connection with the mobile phone.

20. The machine-readable medium of claim 19, the operations further comprising:
transmitting the status information from the mobile phone to a cloud-based communications service, the status information comprising data indicative of the connectivity status of the mobile phone with the mobile network and the existence of the first network connection between the first device and the mobile phone;
wherein the cloud-based communications service includes logic to either permit or inhibit the initiation of the network-based telephone call by the first communication application of the first device, based upon the analysis of the received status information from the mobile phone.
